(19) United States
(12) Patent Application Publication
(10) Pub. No.: US 2026/0254378 A1
(43) Pub. Date: Aug. 27, 2026

(54) TURBO ALTERNATOR OVERSPEED PROTECTION CIRCUIT

(71) Applicant: Blue Origin Manufacturing, LLC, Huntsville, AL (US)

(72) Inventor: Jacob Hoxsey Fenton, Gilbert, AZ (US)

(21) Appl. No.: 19/064,374

(22) Filed: Feb. 26, 2025

(51) Int. Cl. H02P 9/00; H02P 9/08

(52) U.S. Cl. CPC H02P 9/006; H02P 9/08

(57) ABSTRACT

Electrical circuits, systems, and methods for protecting a turbo alternator from an overspeed condition are presented. The turbo alternator may be part of a cryocooler. A system may include a brake circuit to provide voltage clamping on a DC link of the turbo alternator in case of a failure of a controller of the system to maintain the DC link voltage. If the turbo alternator speed is left uncontrolled, the DC link voltage may excessively increase. The turbo alternator may then reach an overspeed condition and destroy itself, such as by bearing failure. The brake circuit may prevent the turbo alternator from such an overspeed condition by operating in view of the DC link voltage. The brake circuit need not require any external input for control and it may be powered from the DC link bus.

### BACKGROUND

Cryocoolers, which may be used for achieving ultra-low temperatures in various applications, such as for scientific research, medical imaging, and space exploration, often include turbo alternators. Turbo alternators efficiently convert mechanical energy into electrical power, driving the cooling process. The operating speed of a turbo alternator is affected both by the load that is placed on it and by external control electronics. If the control electronics fail for some reason, there may be a mechanical load on the turbo alternator that causes the rotation speed of the turbo alternator to increase without limit. For example, the turbo alternator, under load, may accelerate uncontrollably. As the turbo alternator continues to spin faster, it may approach an overspeed condition, which is a point beyond its design limits. In the overspeed regime, the turbo alternator experiences extreme centrifugal forces. such that bearings, shafts, and other components face immense stress. This likely results in a catastrophic failure, which is self-destruction of the turbo alternator.

Cryocoolers may be mission-critical systems in space missions. Preventing overspeed-induced failures may be an important step in ensuring their reliability and safety. Thus, a way to prevent overspeed conditions for turbo alternators would be very useful for ensuring the longevity and stability of these cooling systems.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a system block diagram of a circuit for operating a turbo alternator, according to some embodiments.

FIG. 2 is a schematic diagram of a brake circuit for a turbo alternator, according to some embodiments.

FIG. 3 is a plot illustrating an effect of a brake circuit on a DC link voltage over a time span that includes removal of a normal current load path, according to some embodiments.

FIG. 4 is a flow diagram of a method for protecting a turbo alternator from an overspeed condition, according to some embodiments.

### DETAILED DESCRIPTION

This disclosure describes, among other things, systems and methods for protecting a turbo alternator from an overspeed condition. In some implementations, the turbo alternator may be part of a cryocooler. Some systems may include a brake circuit to provide voltage clamping on a DC link of a turbo alternator in case of a failure of a controller of the system to maintain the DC link voltage. If the turbo alternator speed is left uncontrolled, which may result in the DC link voltage increasing without bounds, the turbo alternator may overspeed and destroy itself (e.g., by bearing failure). The DC link voltage correlates to turbo alternator speed (e.g., higher speed, higher DC link voltage and higher turbo alternator power generation). As the turbo alternator speed increases, the DC link voltage may also increase as the charge on a capacitance of the DC link increases. Accordingly, a brake circuit for preventing the turbo alternator from an overspeed condition may operate in view of the DC link voltage.

In some embodiments, the brake circuit may have a number of characteristics such as, it does not require any external input for control, it may be powered from the DC link bus, it may engage when the DC link voltage exceeds a voltage threshold, and it may dissipate enough power to maintain the DC link at or near the voltage threshold (e.g. and avoid shunting the DC Link with excessive loading). In this way, the brake circuit may be self-biasing and self-regulating.

Generally, a DC link refers to a section of a system that connects the input and output sides of a power conversion system. It acts as an intermediary between different power conversion stages, for example. One function of the DC link is to store energy while the input power exceeds the output power. Conversely, it may release stored energy when the output power demand exceeds the input power. The DC link typically includes an energy storage element, such as a capacitor, which serves as a buffer between different stages of the power conversion process. For example, in a motor control circuit, a DC link capacitor may be placed between a rectifier (which converts AC to DC) and a voltage source inverter (which may generate AC at some frequency). The capacitor generally accepts relatively low-frequency pulses of current from the rectifier. Meanwhile, the inverter draws much higher frequency pulses of current from the capacitor. The incoming and outgoing current pulses rarely coincide in time or magnitude. The DC link capacitor not only allows these pulses to happen at different times and frequencies (acting as an energy buffer), but it also smooths out the current pulses, reducing peak-to-peak ripple.

In some embodiments, an electrical circuit for protecting a turbo alternator from an overspeed condition may comprise a first branch that includes a power converter, a second branch that includes the turbo alternator, a third branch that includes a brake circuit, and a node at which the first, second, and third branches are connected together. Herein, branches refer to individual paths through which current flows. The node is a point in the circuit where the three branches intersect or connect. For example, the node serves as a junction where current can split or combine.

The first branch has an equivalent capacitance at the node. For example, this capacitance may be the combined effect of all capacitors connected to that node from the first branch. The equivalent capacitance represents the net capacitance experienced by the node from all of the connected (e.g., first, second, and third) branches. The first branch may include a DC link and the equivalent capacitance at the node may be at least approximately the capacitance of the DC link.

The circuit may further include a comparator in the third branch to provide a comparison between a voltage across the equivalent capacitance and a threshold voltage, described below. Circuitry in the third branch may be configured to allow current generated by the turbo alternator to enter the third branch. This allowed current may be current that would otherwise flow into the first branch if current flow through the first branch were not interrupted by a fault, for example. Thus, the allowed current is a diverted current. The level (e.g., amount) of the allowed (e.g., diverted) current may be based, at least in part, on the comparison between the voltage across the equivalent capacitance and the threshold voltage. Described differently, the circuitry in the third branch may be configured to block current from entering the third branch from the node based, at least in part, on the comparison between the voltage across the equivalent capacitance and the threshold voltage. The current generated by the turbo alternator that enters the third branch imposes a braking load on the turbo alternator to prevent an overspeed condition, as described below. For example, the brake circuit may include resistive elements to dissipate power generated by the turbo alternator during the overspeed condition.

In some embodiments, a method for protecting a turbo alternator from an overspeed condition may include measuring a DC link voltage across a capacitive region between a power converter and a voltage source inverter (VSI) that are configured to carry current to and from the turbo alternator, comparing the DC link voltage to a threshold voltage to determine a voltage difference and, based at least in part on the voltage difference, diverting current generated by the turbo alternator to a brake circuit to place a load on the turbo alternator.

The power converter may be a 4-switch buck-boost converter (4SBB) and the VSI may be a three phase inverter, such as for when the turbo alternator is a three-phase turbo alternator, for example.

The method may also include dissipating at least a portion of the power generated by the turbo alternator during the overspeed condition by resistive elements at a pulse width modulation frequency that is based, at least in part, on i) the power generated by the turbo alternator during the overspeed condition, ii) the capacitance of the capacitive region, iii) the voltage across the capacitive region, and iv) values of the resistive elements.

The current to the turbo alternator may comprise motor controller signals to control the turbo alternator. Conversely, the current from the turbo alternator may comprise current generated by the turbo alternator.

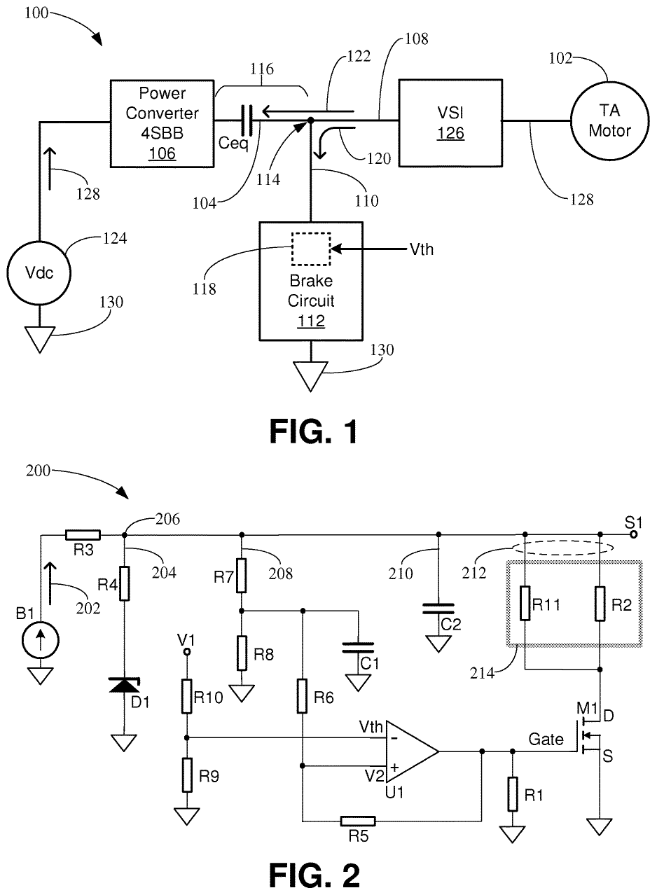

FIG. 1 is a system block diagram of an electrical circuit 100 for operating a turbo alternator 102, according to some embodiments. In particular, the circuit is configured to protect the turbo alternator from an overspeed condition. Circuit 100 may comprise a first branch 104 that includes a power converter 106, a second branch 108 that includes turbo alternator 102, a third branch 110 that includes a brake circuit 112, and a node 114 at which the first, second, and third branches are connected together. First branch 104 may have an equivalent capacitance Ceq at node 114. For example, as mentioned above, this capacitance may be the combined effect of all capacitors and/or capacitive configurations (e.g., stray capacitance, parasitic capacitance, etc.) connected to that node from the first branch (and the other branches). The equivalent capacitance represents, at least in part, the net capacitance experienced by the node from the first branch. The first branch may include a DC link 116 and the equivalent capacitance Ceq in the first branch may be the capacitance of the DC link, for example.

The circuit may further include a comparator 118 in third branch 110 to provide a comparison between a voltage at node 114 and a threshold voltage Vth. In some implementations, brake circuit 112 may include comparator 118, as indicated in the figure.

The voltage at node 114 may increase above normal operating values, for example, if turbo alternator 102 enters into an overspeed condition, wherein excess power generated by the turbo alternator leads to the increase in the voltage at node 114. This may occur if an electrical fault occurs in first branch 104, such as if current flow through power converter 106 is interrupted (e.g., no current path back to a power bus). Threshold voltage Vth may be a priori set to a value such that when the voltage at node 114 surpasses Vth, the current corresponding to the excess power generated by the turbo alternator flows into brake circuit 112 of third branch 110. For example, circuitry, such as comparator 118 and brake circuit 112, in the third branch may be configured to allow current 120 generated by turbo alternator 102 to enter third branch 110. Thus, current 120 may enter third branch 110 during the overspeed condition of the turbo alternator. Current 120 may be current that could otherwise flow into first branch 104, as indicated by arrow 122, depending on results of comparator 118. For example, all current generated by turbo alternator 102 may flow from second branch 108 to first branch 104 if the voltage at node 114 is less than the threshold voltage Vth. This may occur while all electronics in the first branch (e.g., power converter 106) are operating normally and the turbo alternator is not in an overspeed condition. In this case, circuitry, such as comparator 118 and/or brake circuit 112, in third branch 110 may be configured to block current 120 from entering the third branch from node 114 based, at least in part, on the comparison between the two voltages.

On the other hand, some or all current generated by turbo alternator 102 may be diverted from flowing into first branch 104 and instead may be caused to flow from second branch 108 to third branch 110 during an overspeed condition. This may result from the voltage at node 114 being greater than a threshold voltage Vth. The overspeed condition may occur, as mentioned above, during a failure or fault in first branch 104, such as in power converter 106. In this case, a current path in the power converter may be interrupted, resulting in current from the turbo alternator leading to the voltage at node 114 increasing until this voltage surpasses Vth. Resultantly, the circuitry in the third branch may receive current 120 generated by the turbo alternator. This current may then enter brake circuit 112, which imposes a braking load on the turbo alternator. Such a load may reduce (or maintain) the speed of the turbo alternator to below that of an overspeed condition.

In some implementations, the level or amount of current diverted from flowing into first branch 104 and into third branch 110 from second branch 108 may be based, at least in part, on a comparison or difference between the voltage at node 114 and a threshold voltage Vth. For example, such an amount of current may be proportional to the difference between the two voltages, as explained below.

Circuitry, such as comparator 118 and/or brake circuit 112, in the third branch may include radiation-hardened semiconductor components. Since most semiconductor electronic components may normally be susceptible to radiation damage, counterpart radiation-hardened components are generally available. Radiation hardening is a process of making electronic components and circuits resistant to damage or malfunction caused by high levels of ionizing radiation (e.g., particle radiation and high-energy electromagnetic radiation), especially for environments in space (e.g., beyond low-Earth orbit).

Power converter 106, which may be a 4-switch buck-boost converter, may be configured to transmit motor control current from a signal source 124 for turbo alternator 102 to node 114 and to receive, via the node, power generated by the turbo alternator. Second branch 108 may further include a voltage source inverter (VSI) 126 between node 114 and turbo alternator 102. Power/current transmission between VSI 126, which may be a three phase inverter, and turbo alternator 102 may be on three-phase lines 128. Accordingly, the turbo alternator may be a three-phase turbo alternator, for example.

Brake circuit 112 may include resistive elements to dissipate power generated by turbo alternator 102 during an overspeed condition. For example, the power dissipated by the resistive elements may be proportional to current 120. In some implementations, as described below in detail, at least a portion of the power generated by the turbo alternator during the overspeed condition may be dissipated by the resistive elements at a pulse width modulation frequency that is based, at least in part, on i) the power generated by the turbo alternator during the overspeed condition, ii) the capacitance in the first branch, iii) the voltage across the capacitance, and iv) values of the resistive elements.

Considering electrical circuit 100, in some embodiments, a method for protecting turbo alternator 102 from an overspeed condition may include measuring a DC link voltage across capacitive region 116 between power converter 106 and VSI 126, both of which are configured to carry current to and from the turbo alternator. The method further includes comparing the DC link voltage to a threshold voltage Vth to determine a voltage difference.

Based at least in part on the voltage difference, the method also includes diverting current (e.g., current 120) generated by the turbo alternator to brake circuit 112 to place a load on the turbo alternator. The current may be diverted by an amount that is proportional to the voltage difference. The brake circuit may include resistive elements to dissipate power generated by the turbo alternator during the overspeed condition.

A current 128 to the turbo alternator may comprise motor controller signals from signal source 124 to control the turbo alternator. Conversely, current 122 from the turbo alternator may comprise current generated by the turbo alternator. Electrical circuit 100 may use a common ground 130, though claimed subject matter is not limited in this respect.

FIG. 2 is a schematic diagram of a brake circuit 200 for a turbo alternator, such as 102, according to some embodiments. Brake circuit 200 may be the same as or similar to 112, for example. A current source B1 may represent current 120 in circuit 100 such that current 202 produced by current source B1 may be current produced by a turbo alternator (and diverted from first branch 104 to third branch 110) during an overspeed condition.

A resistor R3 may represent a resistance of third branch 110 between node 114 and brake circuit 112. A circuit branch 204 from a node 206 may include a resistor R4 in series with a Zener diode D1, both of which may have values set to determine the voltage drop across the other circuit branches from node 206, namely, a comparator branch 208, a capacitive branch 210, and a power resistor branch 212. Capacitive branch 210 includes C2, which is a relatively small low pass filter to help eliminate noise spikes. In some implementations, circuit branch 204 (e.g., the Zener circuit) may provide local power to bias itself from the DC link. In this way, external power input is not needed to operate brake circuit 200. A large majority of current 202 flows into power resistor branch 212.

Comparator branch 208 includes a first voltage divider, a second voltage divider, and a comparator U1. The first voltage divider comprises resistors R7 and R8 and the second voltage divider comprises resistors R9 and R10. The second voltage divider may determine what part of an input voltage V1 is a threshold voltage (e.g., Vth), which is provided at the negative input of comparator U1. The positive input of comparator U1 may receive a voltage V2 that results from current flowing through the first voltage divider and resistors R6, R5, and R1. Resistors R5 and R6 provide hysteresis to comparator U1 so that the comparator does not easily trigger on noise spikes. C1 is a relatively small low pass filter to eliminate or reduce such noise spikes. The output Vo of comparator U1 may be applied to the gate of a transistor M1, such as a power MOSFET or IGBT, which may be operated in its saturation region.

Thus, transistor M1 is generally either on to allow current to flow through power resistors 214 or M1 is off and current is prevented from flowing through the power resistors. In brake circuit 200, power resistors 214 include R2 and R11, though any number or configuration of resistors (or other elements that can dissipate power) may be included in brake circuit 200 in various cases. Current flow through the power resistors may be pulse width modulated, as described below.

In other implementations, transistor M1 may be operated in its linear region so that the higher the voltage Vo, the greater the amount of current that flows through power resistors 214. Accordingly, the amount of current (e.g., 120) that is diverted into brake circuit 200 may be proportional to the voltage difference between DC link voltage Vₗᵥ and a threshold voltage. A possible disadvantage of operating transistor M1 in its linear region may be that a relatively large amount of power may be dissipated in the transistor instead of substantially all the power being dissipated in the power resistors.

Meanwhile, the change in voltage drop across power resistors 214 (e.g., due to the change in voltage Vo) may change the voltage on node 206, which in turn affects voltage V2, which is the voltage to which Vth is compared. Accordingly, comparator branch 208 and power resistor branch 212 comprise a feedback loop wherein, if M1 is operated in its linear region, the greater the voltage on node 206 (in reference to Vth), the greater the amount of current that is enabled (e.g., via transistor M1) to flow through power resistors 214. If M1 is operated in its saturation region, then current through the power resistors either flows or does not flow (e.g., by pulse width modulation), depending on the voltage on node 206 in reference to Vth. This current and the voltage drop across power resistors 214 is the power that is dissipated in brake circuit 200 to prevent an overspeed condition of the turbo alternator. In this way the power resistors may dissipate enough power to maintain DC link 116 at or near the voltage threshold Vth.

In some implementations, instead of, or in addition to, power resistors 214, as mentioned above, other types of power dissipating elements may be used. For example, instead of dissipating power by converting electrical current (with a voltage drop) into heat, the current may be used to power machinery, instruments, equipment, devices, etc. Generally, this current would be available only during a problematic situation that could lead to overspeed conditions of a turbo alternator. Accordingly, the availability of this current is tentative and it generally could not be relied on for a productive use, such as powering machinery. Regardless, claimed subject matter is not limited in this respect.

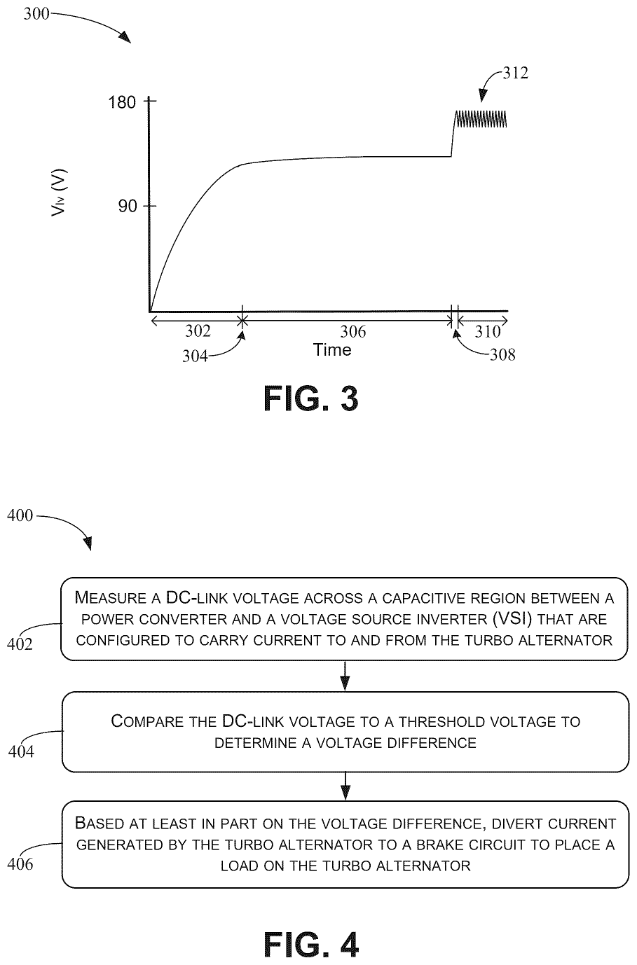

FIG. 3 is a plot 300 illustrating an effect of a brake circuit on a DC link voltage over a time span that includes removal of a normal current load path, according to some embodiments. For example, brake circuit 200 may affect the voltage of DC link 116 if a normal current load path through power converter 106 in first branch 104 were interrupted due to a circuit fault or other detrimental occurrence.

Continuing with the example using electrical circuit 100 and brake circuit 200, during a time span 302, turbo alternator 102 is transitioning into normal operation, such that its increasing rotation speed leads to an increase in DC link voltage Vₗᵥ, which may be the voltage at node 114 (e.g., the DC link capacitance). At time 304, the turbo alternator enters into normal operation, which involves a current path (e.g., a load path) through power converter 106 (e.g., current 122). In this example implementation, DC link voltage Vₗᵥ is about 135 volts during normal operation. At the end of a time span 306, in this illustrative example, the normal load path, such as through power converter 106, is suddenly unavailable. Without this path the DC link voltage Vₗᵥ increases during a time span 308. At the end of this time span, the DC link voltage Vₗᵥ reaches a threshold value, which may be determined in part by V1 in brake circuit 200, for example. (This threshold value and Vth at the negative input of comparator U1 are generally not the same value). When this occurs, the voltage V2 at the positive input of comparator U1 reaches Vth at the negative input and the comparator begins to output a voltage that is applied to the gate of transistor M1. Resultantly, M1 turns on to allow current to flow therethrough. This current flows through power resistors 214 (e.g., R11 and R2). This current is also current that would have otherwise flowed through power convertor 106 if that current path were still available. In other words, this current is current (e.g., current 120) that has been diverted from first branch 104 to brake circuit 200 in third branch 110.

The DC link voltage Vₗᵥ reaches a threshold value and comparator U1 turns on and causes current to flow through transistor M1 and power resistors 214. This in turn causes the DC link voltage Vₗᵥ to decrease. Thus, a goal has been achieved wherein a load (e.g., by power resistors 214) has been imposed on turbo alternator 102 to prevent the turbo alternator from an overspeed condition. The decreasing DC link voltage Vₗᵥ, however, eventually drops below the threshold voltage leading to comparator U1 turning off transistor M1 and blocking current flow through power resistors 214. When this occurs, the DC link voltage Vₗᵥ will suddenly (e.g., at a rate that may at least in part be determined by Ceq in 116) begin to increase again, reaching the threshold voltage so that comparator U1 again turns on transistor M1. Accordingly, current again flows through power resistors 214. This results in the DC link voltage Vₗᵥ decreasing. Thus, during a time period 310 when brake circuit 200 is operating to prevent the turbo alternator from an over speed condition, the DC link voltage Vₗᵥ cycles through this operating loop, as indicated by arrow 312. This has the effect of pulse width modulating (PWM) the current entering brake circuit 200 (and power resistors 214) and the DC link voltage Vₗᵥ. Thus, during time period 310, at least a portion of the power generated by the turbo alternator during an overspeed condition may be dissipated by the resistive elements (e.g., power resistors 214) at a pulse width modulation frequency that is based, at least in part, on the power generated by the turbo alternator during the overspeed condition, the capacitance of the capacitive region (Ceq), the voltage across the capacitive region (Vₗᵥ), and values of the resistive elements in the brake circuit. During time period 310, brake circuit 200 may clamp the DC link voltage at a value that is an average of the PWM voltage.

Returning back to the end of time span 306, when the normal load path (e.g., through power converter 106) is suddenly unavailable, if brake circuit 200 did not exist to impose a load on the turbo alternator, as described above, then the turbo alternator may likely reach an overspeed condition and self-destruct.

FIG. 4 is a flow diagram of a method 400 for protecting a turbo alternator from an overspeed condition, according to some embodiments. In some implementations, method 400 may be performed by circuits that are the same as or similar to 100, which may include brake circuit 200, at least in principle or operation. In such implementations, at 402, the circuit may measure a DC link voltage (e.g., at node 114) (e.g., Ceq) between power converter 106 and VSI 126, both of which are configured to carry current to and from turbo alternator 102. At 404, the circuit may compare the DC link voltage to a threshold voltage to determine a voltage difference. Such comparison may be performed by brake circuit 200. At 406, the circuit may, based at least in part on the voltage difference, divert current (e.g., 120) generated by the turbo alternator to the brake circuit so that a load is placed on the turbo alternator.

The foregoing description, for purposes of explanation, uses specific nomenclature to provide a thorough understanding of the disclosure. It will be apparent to one skilled in the art, however, that specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are illustrated and described to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

1. An electrical circuit for protecting a turbo alternator from an overspeed condition, the electrical circuit comprising:
a first branch including a power converter and a DC link;
a second branch including the turbo alternator;
a third branch including a brake circuit;
a node, wherein the first branch, the second branch, and the third branch are connected together at the node;
a voltage source inverter in the second branch between the node and the turbo alternator;
a DC link capacitance in the first branch at the node;
a comparator in the third branch to provide a comparison between a voltage across the DC link capacitance and a threshold voltage; and
circuitry in the third branch configured to allow current generated by the turbo alternator to enter the third branch, the level of the allowed current based, at least in part, on the comparison, wherein the circuitry is configured, in response to the comparison indicating that the voltage across the DC link capacitance exceeds the threshold voltage after interruption of a current path through the power converter, to divert at least a portion of the current generated by the turbo alternator away from the first branch and into the third branch, thereby imposing a braking load on the turbo alternator.

2. The electrical circuit of claim 1, wherein the braking load reduces or maintains a speed of the turbo alternator below a speed corresponding to the overspeed condition.

3. The electrical circuit of claim 1, wherein the circuitry in the third branch is further configured to block current from entering the third branch from the node based, at least in part, on the comparison between the voltage across the DC link capacitance and the threshold voltage.

4. (canceled)

5. The electrical circuit of claim 1, wherein the power converter is configured to transmit motor control current for the turbo alternator to the node and to receive, via the node, power generated by the turbo alternator.

6. (canceled)

7. The electrical circuit of claim 1, wherein the brake circuit includes resistive elements to dissipate power generated by the turbo alternator during the overspeed condition.

8. The electrical circuit of claim 7, wherein at least a portion of the power generated by the turbo alternator during the overspeed condition is dissipated by the resistive elements at a pulse width modulation frequency that is based, at least in part, on i) the power generated by the turbo alternator during the overspeed condition, ii) the DC link capacitance in the first branch, iii) the voltage across the DC link capacitance, and iv) values of the resistive elements.

9. The electrical circuit of claim 1, wherein the power converter comprises a 4-switch buck-boost converter (4SBB).

10. (canceled)

11. The electrical circuit of claim 1, wherein the circuitry in the third branch includes radiation-hardened semiconductor components.

12-20. (canceled)

21. An electrical circuit for protecting a turbo alternator from an overspeed condition, the electrical circuit comprising:
a power converter coupled to a node, the power converter including a DC link having a capacitance;
a voltage source inverter between the node and the turbo alternator; and
a brake circuit coupled to the node and configured to divert at least a portion of current generated by the turbo alternator away from the power converter when a voltage across the DC link capacitance exceeds a threshold voltage,
wherein the brake circuit is powered from the DC link and configured to control a level of the diverted current based, at least in part, on a comparison or difference between the voltage across the DC link capacitance and the threshold voltage, thereby imposing a braking load on the turbo alternator to limit overspeed.

22. The electrical circuit of claim 21, wherein the brake circuit comprises a bias circuit including a Zener diode configured to derive local operating power for the brake circuit from the voltage at the node such that no external power input is required for operation of the brake circuit.

23. The electrical circuit of claim 21, wherein the brake circuit comprises:
a comparator configured to compare a voltage across the DC link capacitance to the threshold; and
a transistor having a control terminal driven by an output of the comparator and a conduction path coupled to one or more power-dissipating elements,
wherein the transistor controls diversion of the current into the brake circuit.

24. The electrical circuit of claim 21, wherein the brake circuit further comprises a hysteresis network coupled to the comparator to provide a hysteresis band that inhibits diversion in response to transient noise spikes.

25. The electrical circuit of claim 21, wherein the brake circuit further comprises a low-pass filter capacitor coupled to an input of the comparator to attenuate high-frequency noise on the sensed voltage.

26. The electrical circuit of claim 21, wherein the transistor is configured to operate in a saturation region such that the diverted current is pulse-width-modulated in response to the comparator switching as the sensed voltage cycles about the threshold.

27. The electrical circuit of claim 21, wherein the transistor is configured to operate in a linear region such that the diverted current increases as the difference between the sensed voltage and the threshold increases, providing proportional braking.

28. The electrical circuit of claim 21, wherein the one or more power-dissipating elements include a plurality of power resistors configured to dissipate a majority of the diverted current during the overspeed condition.

29. The electrical circuit of claim 21, wherein the brake circuit is configured to clamp the voltage across the DC link capacitance at or near the threshold while avoiding shunting of the DC link with excessive loading.

30. The electrical circuit of claim 1, wherein the brake circuit is configured to clamp the voltage across the

31. The electrical circuit of claim 1, wherein the circuitry in the third branch is configured to divert the at least a portion of the current generated by the turbo alternator in response to the voltage across the DC link capacitance increasing due to the interruption of the current path through the power converter.

32. The electrical circuit of claim 1, wherein the at least a portion of the current generated by the turbo alternator comprises current that would otherwise flow into the first branch through the node absent the interruption of the current path through the power converter.
